(19) United States
(12) Patent Application Publication
(10) Pub. No.: US 2018/0232921 A1
(43) Pub. Date: Aug. 16, 2018

(54) Digital Experience Content Personalization and Recommendation within an AR or VR Environment

(71) Applicant: Adobe Systems Incorporated, San Jose, CA (US)

(72) Inventors: Kevin Gary Smith, Lehi, UT (US); William Brandon George, Pleasant Grove, UT (US)

(73) Assignee: Adobe Systems Incorporated, San Jose, CA (US)

(21) Appl. No.: 15/432,562

(22) Filed: Feb. 14, 2017

(51) Int. Cl. G06T 11/60; G06F 3/01; G06Q 30/02

(52) U.S. Cl. CPC G06T 11/60; G06Q 30/0201; G06F 3/011

(57) ABSTRACT

Digital experience content personalization and recommendation techniques within an AR or VR environment are described. In one example, a user profile is received that models how user interaction occurs with respect to virtual objects within a virtual or augmented reality environment. Digital experience content is obtained that defines a virtual or augmented reality environment. A virtual object is selected for inclusion as part of the digital experience content based at least in part on the user profile. Digital experience content is generated to support user interaction with the selected virtual object as part of the virtual or augmented reality environment.

### BACKGROUND

Techniques have been developed to expand a richness in display and interaction with digital content. Examples of this include virtual reality and augmented reality. In augmented reality, digital experience content is created by a computing device that employs virtual objects to augment a user's direct view of a physical environment in which the user is disposed. In other words, this direct view of the physical environment is not recreated as part of an augmented reality environment but rather the user actually “sees what is there.” The virtual objects are then used to augment the user's view of this physical environment, such as to play a building game of virtual blocks on a physical table top. On the other hand, in virtual reality the computing device generates digital experience content to recreate a user's environment such that the physical environment is not viewable by the user. Accordingly, in virtual reality an entirety of the user's view of created virtually as part of the environment by the computing device.

Although digital experience content in both virtual and augmented reality have expanded a richness of user interaction, techniques and systems used to personalize virtual objects for inclusion as part of these environments have not expanded to address this richness. In a digital marketing content scenario, for instance, conventional digital marketers target digital marketing content (e.g., application notifications, banner ads) based on which items of digital marketing content has been exposed to a user and actions (e.g., conversion of a good or service) that resulted from this exposure. Consequently, conventional digital marketing techniques are limited to addressing what items of digital marketing content have been exposed to the users, but fail to address how interaction with those items occurred.

### SUMMARY

Digital experience content personalization and recommendation techniques within an AR or VR environment are described. In one example, a user profile is generated to model how user interaction occurred with respect to virtual objects within an augmented or virtual reality environment and thus is not limited to solely describing “what” virtual objects are subject of the user interaction.

The “how” of the user interaction, for instance, may be based on different types of user interaction supported by virtual objects (e.g., pick up and move, view on a wall, listen versus view), different amounts of user interaction supported by virtual objects (e.g., respond to queries versus output of notifications), different levels of output supported by the virtual object (e.g., different audio volume levels, visual display sizes), different types of output supported by the virtual objects (e.g., visual versus audio), and so on. Through modeling of the “how” of the user interaction, the user profile may describe user interaction within an augmented or virtual reality environment that takes into account the increased richness in user interaction available from these environments. Consequently, this modeling also supports a variety of technical advantages including accuracy in techniques that rely on the user profile, such as to target digital marketing content in a computationally efficient manner, form recommendations, and so forth. Thus, these techniques may aid to leverage capabilities of these environments in ways that are not possible using conventional item-based personalization techniques.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures may be indicative of one or more entities and thus reference may be made interchangeably to single or plural forms of the entities in the discussion.

FIG. 1 is an illustration of an environment in an example implementation that is operable to employ digital experience content personalization and recommendation techniques described herein.

FIG. 2 is an illustration of a digital medium environment in an example implementation showing a computing device of FIG. 1 in greater detail as configured for rendering of a virtual or augmented reality environment.

FIG. 3 depicts an example implementation of rendering of digital experience content that defines a virtual or augmented reality environment as including a street scene and virtual objects.

FIG. 4 depicts a system in an example implementation showing generation of a user profile and use of the generated user profile to personalize virtual objects as part of generating digital experience content.

FIG. 5 is a flow diagram depicting a procedure in an example implementation involving generation of a user profile that models how user interaction occurs with respect to virtual objects within a virtual or augmented reality environment.

FIG. 6 is a flow diagram depicting a procedure in an example implementation involving use of a user profile that models how user interaction occurs with respect to virtual objects within a virtual or augmented reality environment to control generation of digital experience content.

FIG. 7 depicts a system in an example implementation showing generation of a user profile and use of the generated user profile to recommend digital experience content.

FIG. 8 depicts a procedure involving generation of a user profile that models user interaction with a plurality of items of digital experience content and use of the user profile to generate a digital experience content recommendation.

FIG. 9 illustrates an example system including various components of an example device that can be implemented as any type of computing device as described and/or utilize with reference to FIGS. 1-8 to implement embodiments of the techniques described herein.

### DETAILED DESCRIPTION

Overview

Digital experience content is used by a computing device to define an augmented or virtual reality environment that supports increased richness of user interaction. The user, for instance, may be exposed by the computing device to an immersive environment that supports an ability to see, hear, and manipulate virtual objects through rendering of the digital experience content. As a result, digital experience content increases a richness of a visual, audio, and even tactile output to a user over conventional digital content output techniques, e.g., television.

However, conventional techniques used by a computing device to personalize virtual objects for inclusion as part of these environments do not address this richness, but rather are based solely on exposure of particular virtual objects to the user and resulting actions. As a result, insight gained from these conventional techniques is limited to a subject to the user interaction (e.g., a particular advertisement), and do not address how the user interaction may occur with the AR or VR environment.

Digital experience content personalization and recommendation techniques and systems within an AR or VR environment are described. In one example, a user profile is generated from user interaction data that describes how user interaction occurs with virtual objects in the environment. This may be used in addition to what virtual objects are subject of this interaction to provide additional insight into potential desires of a corresponding user. The user profile, for instance, may model the user interaction using machine learning to describe different ways in how the user chooses to interact with virtual objects. Example of this include different types of user interaction supported by virtual objects (e.g., pick up and move, view on a wall, listen versus view), different amounts of user interaction supported by virtual objects (e.g., respond to queries versus output of notifications), different levels of output supported by the virtual object (e.g., different audio volume levels, visual display sizes), different types of output supported by the virtual objects (e.g., visual versus audio), and so on. In this way, the user profile may act not only as a guide to different items of virtual objects that may be of interest to the user, but also how the user chooses to interact with the virtual objects.

A user profile, for instance, may indicate that a user prefers to read and not listen to virtual objects, i.e., would rather read textual information than listen to it. The computing device, based on the user profile, may thus select virtual objects based on this preferred “how” user interaction is to occur with the user based on the profile, e.g., to output a textual notification on a virtual billboard as opposed to a virtual speaker system. In this way, the computing device has an increased likelihood and thus computational efficiency by outputting virtual objects within a virtual or augmented reality environment that are of interest to the user, e.g., to increase a likelihood of conversion or other aspects of a user's overall experience.

The user profile may also be used to model user interaction with digital experience content as a whole and thus serve as a basis to recommend other digital experience content. The user profile, for instance, may be generated through machine learning by a computing device to describe user interaction with digital experience content, i.e., content used to define an augmented or virtual reality environment. The user profile may then be leveraged by the computing device to recommend digital experience content, which may be based at least in part on data describing another item of digital experience content.

For example, suppose the user navigates through a street in a virtual reality environment output by a computing device of a city of interest. Once the user reaches an intersection in this environment, the computing device may recommend other digital experience content (e.g., other cities) based on the current city and the user profile. In an implementation, the computing device also forms transition data to support a transition between these experiences are part of output of the environment. Thus, the user profile may support personalization within digital experience content as well as personalization between different items of digital experience content. Further discussion of these and other examples is included in the following sections and shown in corresponding figures.

### Term Examples

“Digital experience content” is used by a computing device to define an immersive environment as part of a virtual or augmented reality environment.

“Virtual objects” are content that is used to represent objects that are “not really there” as part of the virtual or augmented reality environment. Examples of virtual objects include augmentations, virtual human entities, stores, and so forth.

A “user profile” is used to model user behavior. In one example, the user profile models user interaction with digital experience content and serves as a basis to form recommendations of other items of digital experience content. In another example, the user profile models “how” user interaction occurs with respect to virtual objects. The “how” of the user interaction, for instance, may be based on different types of user interaction supported by virtual objects (e.g., pick up and move, view on a wall, listen versus view), different amounts of user interaction supported by virtual objects (e.g., respond to queries versus output of notifications), different levels of output supported by the virtual object (e.g., different audio volume levels, visual display sizes), different types of output supported by the virtual objects (e.g., visual versus audio), and so on.

In the following discussion, an example environment is first described that may employ the techniques described herein. Example procedures are also described which may be performed in the example environment as well as other environments. Consequently, performance of the example procedures is not limited to the example environment and the example environment is not limited to performance of the example procedures.

Example Environment

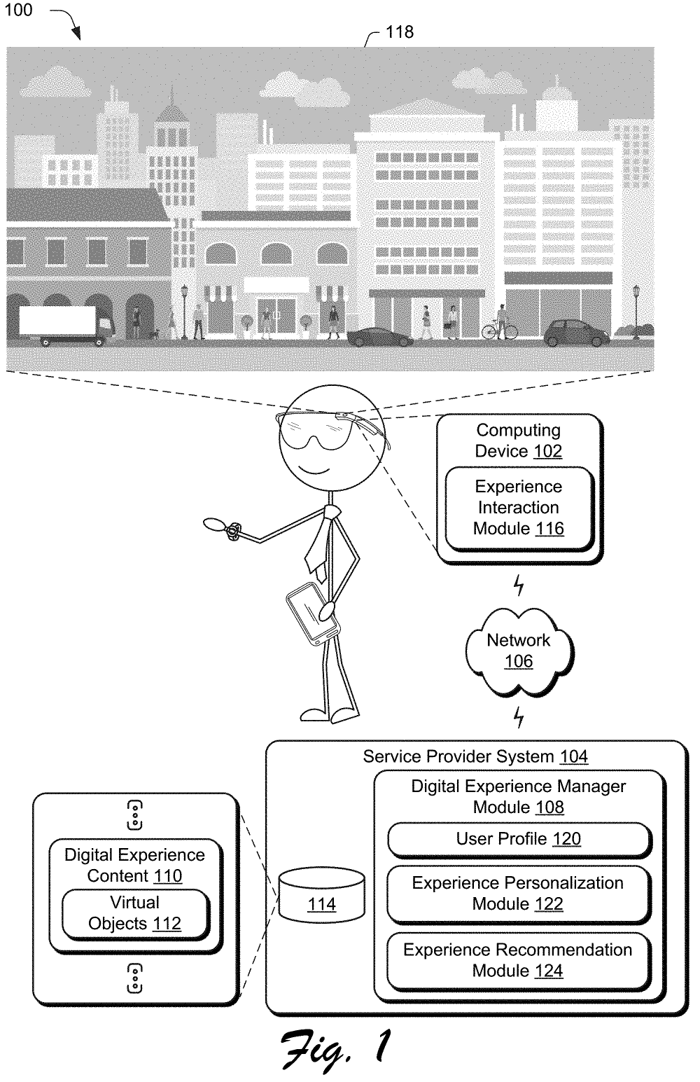

FIG. 1 depicts an example digital medium environment 100 configured to support digital experience content personalization and recommendation techniques within an AR or VR environment. The digital medium environment 100 as illustrated in this example includes a computing device 102 and a service provider system 104 that are communicatively coupled, one to another, via a network 106. The computing device 102 and service provider system 104 may be implemented using a variety of different types of computing devices in a variety of configurations.

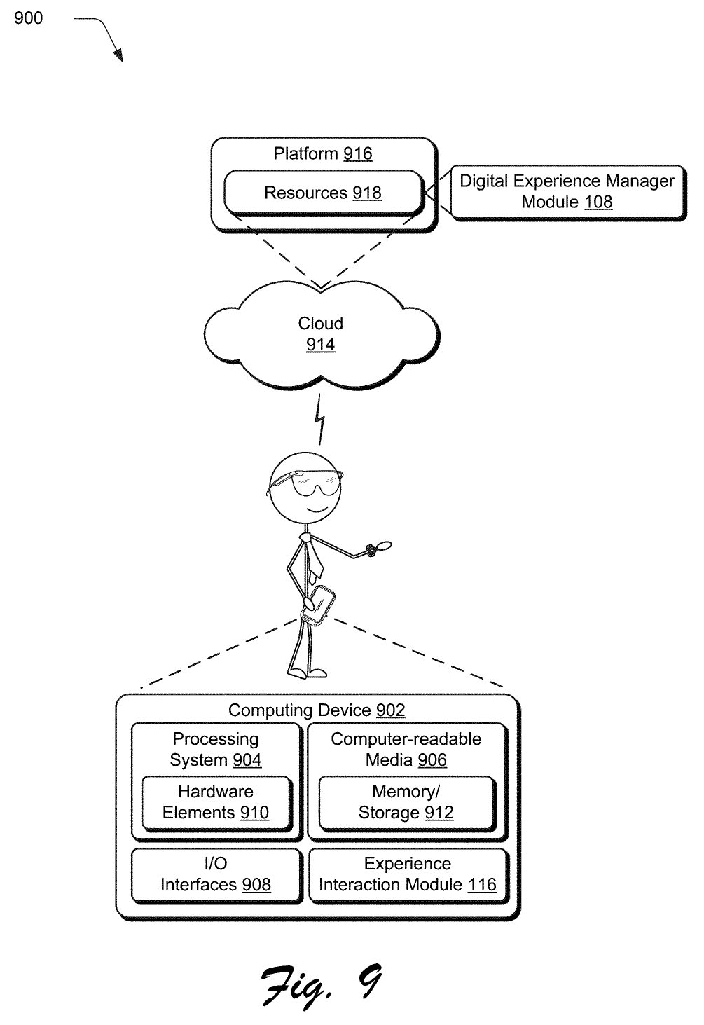

A computing device, for instance, may be configured as a desktop computer, a laptop computer, a mobile device (e.g., assuming a handheld configuration such as a tablet or mobile phone), worn by a user as goggles or other eyewear, and so forth. Thus, a computing device may range from full resource devices with substantial memory and processor resources (e.g., personal computers, game consoles) to a low-resource device with limited memory and/or processing resources (e.g., mobile devices). Additionally, although a single computing device is shown by way of example, the computing device may be representative of a plurality of different devices, such as multiple servers utilized by a business to perform operations “over the cloud” as described in FIG. 9.

The service provider system 104 is further illustrated as including a digital experience manager module 108. The digital experience manager module 108 is implemented at least partially in hardware of at least one computing device (e.g., a processing system and computer-readable storage medium) to manage generation, storage, and provision of digital experience content 110 and associated virtual objects 112, which are illustrate as stored in storage 114, e.g., a computer-readable storage media, database system, and so forth. The computing device 102, for instance, may receive the digital experience content 110 and render it using an experience interaction module 116 for viewing by a user, a rendered example 118 of which is illustrated as a street scene of a city. A user of the computing device 102 may then interact with the rendered example 118, e.g., to view, listen to, navigate between, and even manipulate virtual objects 112. Thus, augmented and virtual reality environments provide an immersive experience to a user of the computing device 102.

Further, this immersion may be leveraged to support a variety of personalization and recommendation scenarios using virtual objects 112 that are not possible using conventional techniques. Illustrated examples of functionality to support this personalization by the service provider system 104 include a user profile 120, an experience personalization module 122, and an experience recommendation module 124.

The user profile 120 is used to model user interaction with virtual objects 112 within a virtual or augmented reality environment. The user profile 120, for instance, may be used to model user interaction with particular virtual objects 112 and actions that result from this user interaction, e.g., conversion of a good or service after exposure to virtual objects configured as digital marketing content 110. Accordingly, the digital experience manager module 108 may select virtual objects 112 to be generated as part of the digital experience content 110 to improve a user's experience with the content.

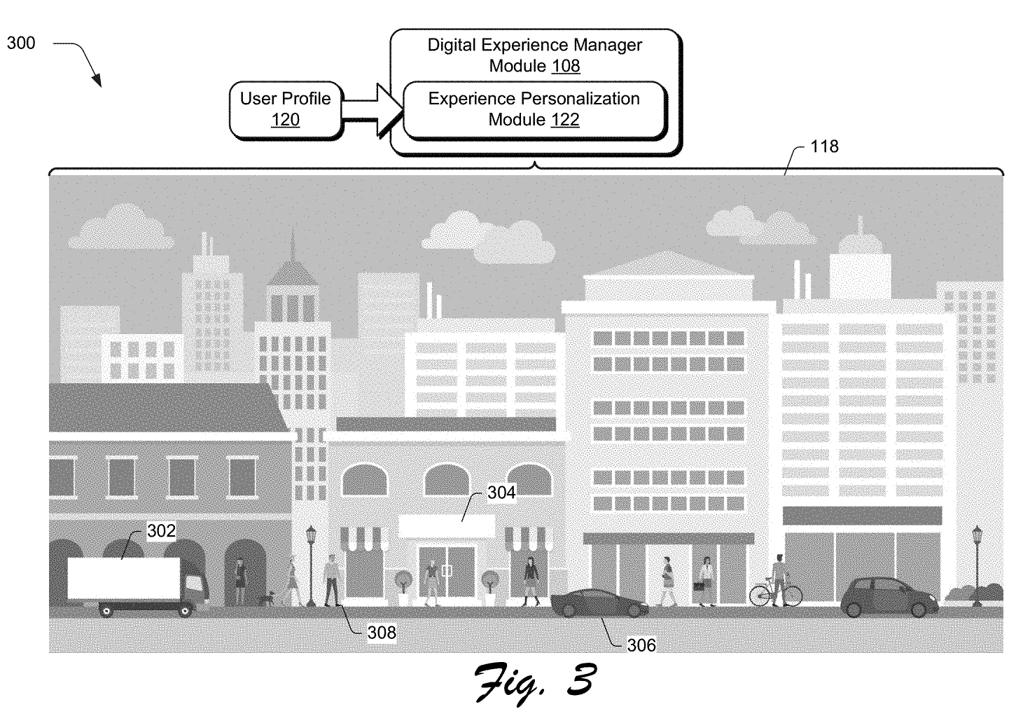

The user profile 120 may also be used to describe “how” user interaction occurs with virtual objects 112 and thus support increased richness over conventional techniques that rely on merely indicating whether or not the interaction did or did occur. This increased richness in the description of the user interaction may then be leveraged as part selecting virtual objects 112 for inclusion as part of digital experience content 110, i.e., as part of a virtual or augmented reality environment defined by this content. In this way, the virtual objects have increased likelihood of being of interest to the user by supporting modeled user interactions involving how the user prefers to interact with the virtual objects. Further discussion of personalization techniques and systems is included in a corresponding section in the following description and shown in FIGS. 3-6.

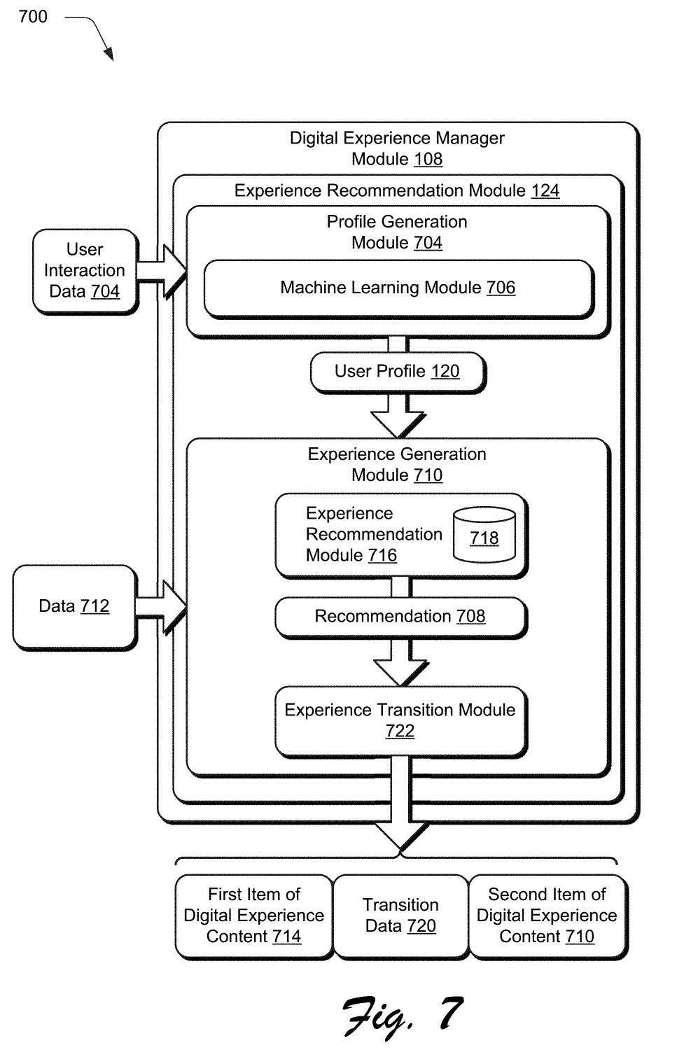

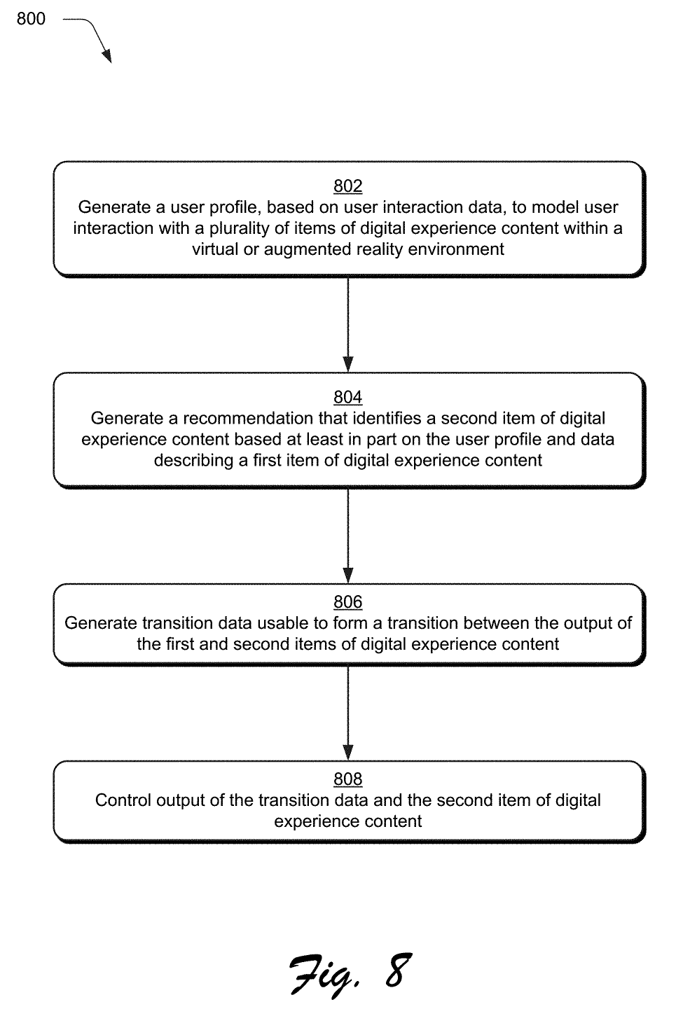

The user profile 120 is also usable by the computing device 102 to generate recommendations regarding the digital experience content 110 itself as a whole. The user profile 120, for instance, may describe items of digital experience content 110 and corresponding actions and from this form recommendations regarding other items of digital experience content. Further discussion of recommendations is included in a corresponding section in the following and described in relation to FIGS. 7-8.

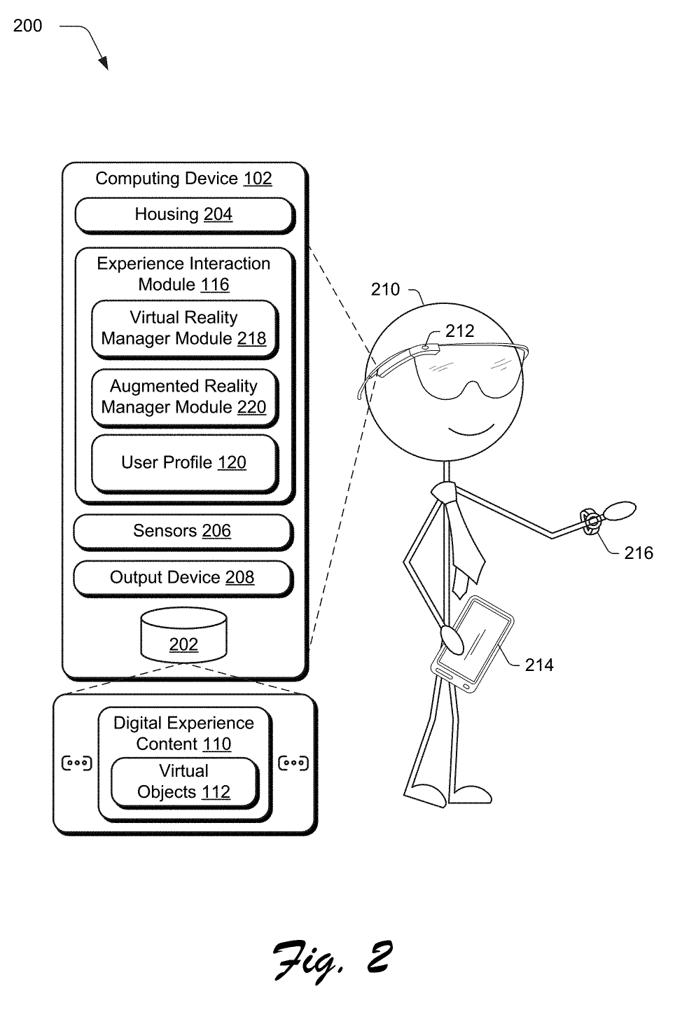

FIG. 2 is an illustration of a digital medium environment 200 in an example implementation showing the computing device 102 of FIG. 1 in greater detail. The illustrated environment 100 includes the computing device 102 of FIG. 1 as configured for use in augmented reality and/or virtual reality scenarios, which may be configured in a variety of ways.

The computing device 102 is illustrated as including the experience interaction module 116 that is implemented at least partially in hardware of the computing device 102, e.g., a processing system and memory of the computing device as further described in relation to FIG. 9. The experience interaction module 116 is configured to manage rendering of and user interaction with digital experience content 110 and corresponding virtual objects 112. The digital experience content 110 is illustrated as maintained in storage 202 of the computing device 102.

The computing device 102 includes a housing 204, one or more sensors 206, and an output device 208, e.g., display device, speakers, and so forth. The housing 204 is configurable in a variety of ways to support user interaction as part of the digital experience content 110, i.e., an augmented or virtual reality environment defined by the content. In one example, the housing 204 is configured to be worn on the head of a user 210 (i.e., is “head mounted” 212), such as through configuration as goggles, glasses, contact lens, and so forth. In another example, the housing 204 assumes a hand-held 214 form factor, such as a mobile phone, tablet, portable gaming device, and so on. In yet another example, the housing 204 assumes a wearable 216 form factor that is configured to be worn by the user 110, such as a watch, broach, pendant, or ring. Other configurations are also contemplated, such as configurations in which the computing device 102 is disposed in a physical environment apart from the user 210, e.g., as a “smart mirror,” wall-mounted projector, television, and so on.

The sensors 206 may also be configured in a variety of ways to detect a variety of different conditions. In one example, the sensors 206 are configured to detect an orientation of the computing device 102 in three-dimensional space, such as through use of accelerometers, magnetometers, inertial devices, radar devices, and so forth. In another example, the sensors 206 are configured to detect environmental conditions of a physical environment in which the computing device 102 is disposed, such as objects, distances to the objects, motion, colors, and so forth. A variety of sensor configurations may be used, such as cameras, radar devices, light detection sensors (e.g., IR and UV sensors), time of flight cameras, structured light grid arrays, barometric pressure, altimeters, temperature gauges, compasses, geographic positioning systems (e.g., GPS), and so forth. In a further example, the sensors 206 are configured to detect environmental conditions involving the user 210, e.g., heart rate, temperature, movement, and other biometrics.

The output device 208 is also configurable in a variety of ways to support a virtual or augmented reality environment through visual, audio, and even tactile outputs. Examples of which include a typical display device found on a mobile device such as a camera or tablet computer, a light field display for use on a head mounted display in which a user may see through portions of the display, stereoscopic displays, projectors, television (e.g., a series of curved screens arranged in a semicircular fashion), and so forth. Other configurations of the output device 208 may also be included as part of the computing device 102, including devices configured to provide user feedback such as haptic responses, audio sounds, and so forth.

The housing 204, sensors 206, and output device 208 are also configurable to support different types of user experiences by the experience interaction module 116. In one example, a virtual reality manager module 218 is employed to support virtual reality. In virtual reality, a user is exposed to an immersive environment, the viewable portions of which are entirely generated by the computing device 102. In other words, everything that is seen and heard by the user 210 is rendered and displayed by the output device 118 (e.g., visual and sound) through use of the virtual reality manager module 218 by rendering the digital experience content 110.

The user 210, for instance, may be exposed to virtual objects 112 that are not “really there” (e.g., virtual bricks) and are displayed for viewing by the user in an environment that also is completely computer generated. The computer-generated environment may also include representations of physical objects included in a physical environment of the user 210, e.g., a virtual table that is rendered for viewing by the user 210 to mimic an actual physical table in the environment detected using the sensors 206. On this virtual table, the virtual reality manager module 218 may also dispose virtual objects that are not physically located in the physical environment of the user 210, e.g., the virtual bricks as part of a virtual playset. In this way, although an entirely of the display being presented to the user 210 is computer generated, the virtual reality manager module 218 may represent physical objects as well as virtual objects within the display.

The experience interaction module 116 is also illustrated as supporting an augmented reality manager module 220. In augmented reality, the digital experience content 110 is used to augment a direct view of a physical environment of the user 210. The augmented reality manger module 220, for instance, may detect landmarks of the physical table disposed in the physical environment of the computing device 102 through use of the sensors 206, e.g., object recognition. Based on these landmarks, the augmented reality manager module 220 configures the virtual objects 112 to be viewed within this environment.

The user 210, for instance, may view the actual physical environment through head-mounted 212 goggles. The head-mounted 212 goggles do not recreate portions of the physical environment as virtual representations as in the VR scenario above, but rather permit the user 210 to directly view the physical environment without recreating the environment. The virtual objects 112 are then displayed by the output device 208 to appear as disposed within this physical environment. Thus, in augmented reality the virtual objects 112 augment what is “actually seen and heard” by the user 210 in the physical environment. In the following discussion, the digital experience content 112 and included virtual objects 112 may be rendered by the experience interaction module 116 in both a virtual reality scenario and an augmented reality scenario.

The experience interaction module 116 is also illustrated as including the user profile 120 as maintained locally by the computing device 102. As previously described, the user profile 120 is usable by the computing device 102 to personalize virtual objects based on how user interaction that occurs within the augmented or virtual reality environment. Further discussion of personalization is included in a corresponding section in the following and described in relation to FIGS. 3-6. The user profile 120 is also usable by the computing device 102 to generate recommendations regarding the digital experience content 110 itself as a whole. Further discussion of recommendations is included in a corresponding section in the following and described in relation to FIGS. 7-8.

In general, functionality, features, and concepts described in relation to the examples above and below may be employed in the context of the example procedures described in this section. Further, functionality, features, and concepts described in relation to different figures and examples in this document may be interchanged among one another and are not limited to implementation in the context of a particular figure or procedure. Moreover, blocks associated with different representative procedures and corresponding figures herein may be applied together and/or combined in different ways. Thus, individual functionality, features, and concepts described in relation to different example environments, devices, components, figures, and procedures herein may be used in any suitable combinations and are not limited to the particular combinations represented by the enumerated examples in this description.

Digital Experience Content Personalization

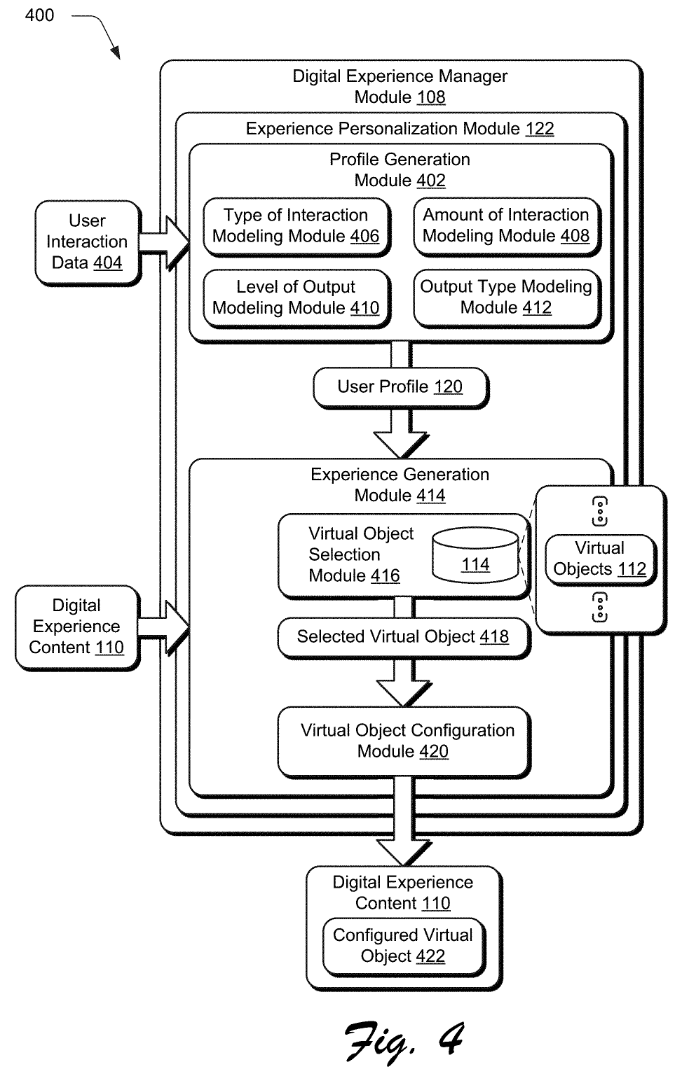

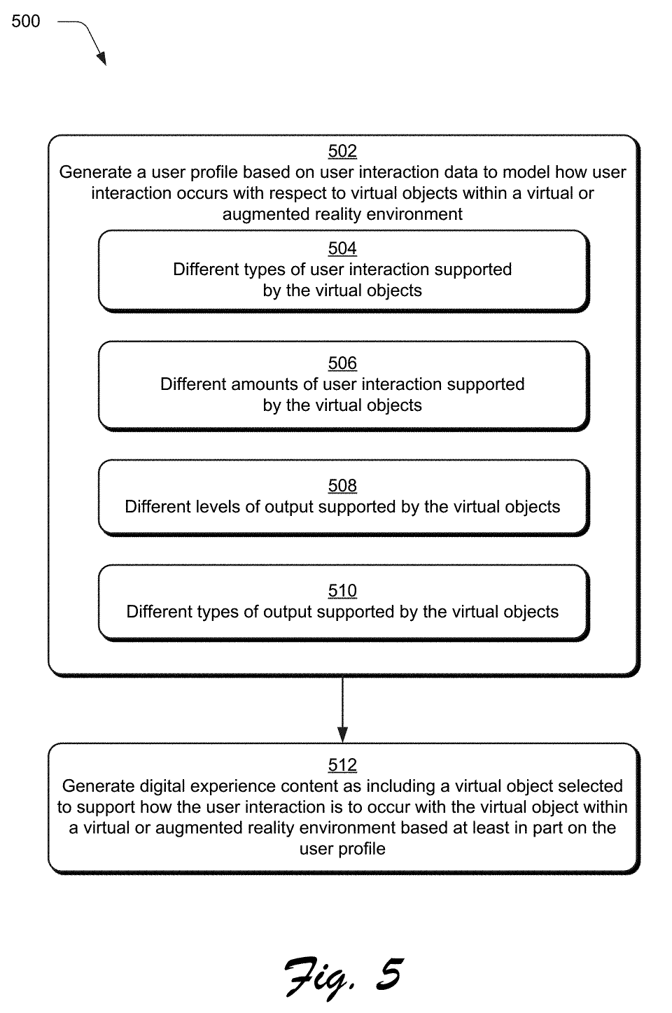

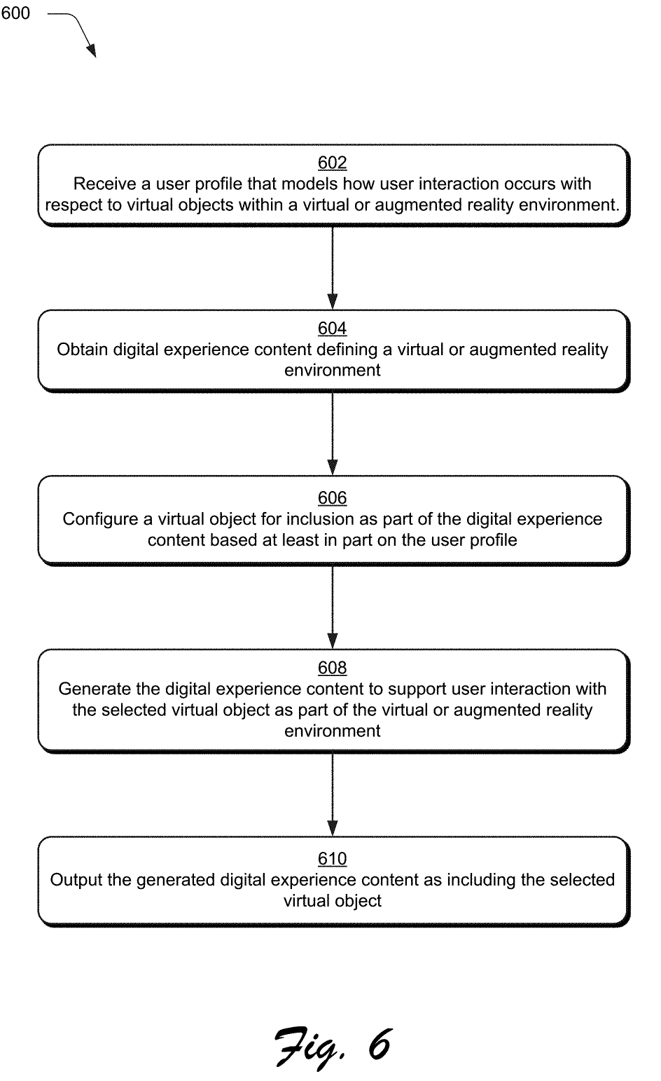

FIG. 3 depicts an example implementation 300 of rendering of digital experience content 110 that defines a virtual or augmented reality environment as including a street scene and virtual objects. FIG. 4 depicts a system 400 in an example implementation showing generation of a user profile and use of the generated user profile to personalize virtual objects as part of generating digital experience content. FIG. 5 depicts a procedure 500 involving generation of a user profile that models how user interaction occurs with respect to virtual objects within a virtual or augmented reality environment. FIG. 6 depicts a procedure 600 involving user of a user profile that models how user interaction occurs with respect to virtual objects within a virtual or augmented reality environment to control generation of digital experience content.

The following discussion describes techniques that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference is made interchangeably to FIGS. 3-6.

The rendered example 118 of digital experience content provides an immersive augmented or virtual reality experience, which in this instance involves a street scene of a city. As previously described, augmented and virtual reality experiences increase a richness of a user's ability to interact with the environment. Thus, this expanded ability to interact with the virtual or augmented reality environment, and namely the “how” this interaction occurs, may be used to personalize virtual objects for inclusion as part of generating the digital experience content and thus inclusion within the environment. For example, virtual objects may be selected and personalized to include signage 302, 304 on vehicles and stores, include particulars object such as a car 306 to be advertised, use of virtual user entities 308 that are configured to converse audibly about particular topics, and so on. In this way, the user profile 120 may describe both what the user is interested in as well as how the user desires to interact within an AR or VR environment and is used to generate a digital content experience having objects that are configured to support the “how” of this modeled interaction.

To begin, a user profile 120 is generated by a profile generation module 404 based on user interaction data 404 to model how user interact occurs with respect to virtual objects within a virtual or augmented reality environment (block 502). The profile generation module 402, for example, may employ machine learning techniques such as neural networks (e.g., convolutional, deep learning, regression) to learn a model to describe how interaction occurs with virtual objects within a virtual or augmented reality environment. The user interaction data 404, for instance, may be collected using sensors 206 of the computing device 102, result from monitoring performed by the service provider system 104 as part of providing the digital experience content 110 (e.g., via streaming), and so forth. The user interaction data 404 may be configured to describe virtual objects 112, with which, the user 210 has interacted as well as how this interaction occurred. In this way, the user profile 120 may be used to describe in which way a user 210 descried by the user interaction data 404 desires to interact with virtual objects.

A variety of differences may be modeled in describing “how” the user interacts with virtual object 122. In one example, a type of interaction modeling module 406 is employed by the profile generation module 402 to model different types of user interaction supported by the virtual objects (block 504). The types of user interaction how the user 210 may provide inputs and interact with the virtual objects 108. Example of types of user interaction include manual manipulation (e.g., virtual handling of the virtual objects 108, typing), spoken interaction (e.g., verbal commands and conversation), visual interaction (e.g., how a user is permitted to view the objects, gaze tracking, and gaze duration), and so forth. Thus, modeling of types of user interaction may give insight into the user regarding the types of user interaction preferred by the user when interacting with an augmented or virtual reality environment.

In another example, different amounts of user interaction supported by the virtual objects is modeled (block 506) by an amount of interaction modeling module 408. The virtual objects, for instance, may support a search query but not a natural language query, configured to be viewed (e.g., painted on a wall) but not moved (e.g., “picked up” by the user), and so forth. Thus, the different amounts of user interaction may describe a richness afforded by the virtual objects in user interaction as part of an augmented or virtual reality environment. Consequently, modeling of the different amounts of user interaction provides insight regarding a richness in the user interaction preferred by the user. For example, the user may prefer to read information but not grab objects within the environment and listen to audio notifications but not engage in a virtual conversation. Accordingly, the modeling of these different amounts of user interaction may be used to personalize subsequent virtual objects in a manner that is consistent with the model and thus likely of interest to the user.

In a further example, different levels of output supported by the virtual objects is modeled (block 508) by a level of output modeling model 410. The level of output, for instance, may describe an intensity in a corresponding type of output by virtual objects, such as volume level, brightness, display size, and so forth. Consequently, modeling of the different output levels of virtual objects provides insight regarding an intensity in the output of these objects as part of user interaction preferred by the user. For example, the user may prefer relatively large amounts of crowd noise, but tends to ignore virtual objects having a relatively small size. Accordingly, this modeling may be used to personalize subsequent virtual objects in a manner that is consistent with the model and thus likely of interest to the user.

Different types of output supported by the virtual objects may also be modeled (block 510). Virtual objects, for instance, may support different types of output, such as to be seen, heard, as well as how the virtual objects are seen or heard. Virtual objects, for instance, may be configured for placement on other virtual objects, e.g., painted on a wall, included on signage of a billboard or store, and so forth. In an audio example virtual objects may be output as an audio notification (e.g., via a virtual loudspeaker system), as part of an “overheard” conversation by virtual human entities within the environment, and so forth. Thus, modeling of the different types of output may give insight into desires in how the user desires to receive information within the environment.

Digital experience content is then generated as including a virtual object selected to support how the user interaction is to occur with the virtual object within the virtual or augmented reality environment based at least in part on the user profile (block 512). The profile generation module 402, for instance, may output the user profile 120 that is generated from the user interaction data 40 to an experience generation module 414 to guide generation of digital experience content 110 to include virtual objects that are configured to comply with the “how” user interaction is likely desired by a user based on the user profile 120.

The experience generation module 414, for instance, may receive a user profile 120 that models how user interact occurs with respect to virtual objects within a virtual or augmented reality environment (block 602) as generated by the profile generation module 402 or elsewhere. Digital experience content 110 is also obtained by the experience generation module 414 that defines a virtual or augmented reality environment (block 604). The experience generation module 414 then employs the user profile 120 to process the digital experience content 110 using machine learning to select and configure virtual objects for inclusion as part of the digital experience content 110.

The experience generation module 414, for instance, may employ a virtual object selection module 416 to select a virtual object from a plurality of virtual objects 112 that are maintained in storage 114 based on machine learning. The virtual object selection module 416, for instance, may employ machine learning as applied to the user profile 120 and digital experience content 110 to select a virtual object from the plurality of virtual objects 112, at least in part, based on the modeled “how” of the user interaction with virtual object. In one example, this is performed by generating scores for each type of modeled interaction, amount of interaction, level of output, and output type defines by the user profile 120 as applied to the digital experience content 110 and corresponding virtual objects 112. In this way, the virtual object selection module 416 may select objects that are relevant to the digital experience content 110 and that exhibited characteristics that are consistent with the described “how” user interaction is to occur as indicated by the user profile 120.

A virtual object is then configured by a virtual object configuration module 420 for inclusion as part of the digital experience content 110 based at least in part on the user profile 120 (block 606). The selected virtual object 418, for instance, may be configured for inclusion at a particular location within an augmented or virtual reality environment as described by the digital experience content 110, for output using an indicated type of interaction, amount of interaction, level of output, output type, and so forth. The digital experience content 110 is generated to support user interaction with the selected virtual object 418 as part of the virtual or augmented reality environment (block 608) and is output as including the selected virtual object (block 610). This may be used to support a variety of usage scenarios, examples of which are described in the following discussion.

In a digital marketing scenario, rather than rely on interruptive marketing (e.g., commercials, interstitials, popups etc.), text marketing or surrounding marketing (e.g., display), augmented and virtual reality environments provide opportunities for immersive and truly natural marketing. For example, augmented and virtual reality environments allow for digital marketing system to advertise in real world and word-of-mouth type experiences. In a virtual environment, for instance, targeting may be performed to provide a virtual equivalent of a display of an advertisement on the wall of a hallway a user 210 “walks down” or control product placement in a room through user of virtual objects 112.

Virtual objects and configuration of the virtual objects may also support other less intrusive and more natural ways of user interaction based on the user profile. In this example, a conversation or other spoken utterance by virtual human entities within an augmented or virtual reality environment is used by virtual objects. Consider a museum application that is used to support a tour within a virtual museum as part of a virtual environment or even the real physical museum as part of an augmented reality environment. Conventional applications that did not support such environments may be limited to providing a list of items and display, which are then “clicked” to obtain additional details, recommendations, and so forth. Virtual objects output as part of an augmented or virtual reality environment, on the other hand, allow the user to interact in a manner that mimics that real world. For example, rather than outputting a conventional list of recommendations, virtual objects 112 may be configured as virtual couple that discusses an item of interest that they had just “looked at” using terminology that the experience personalization module 112 may determine that is likely to appeal to the user based on the user profile 120. In this way, the virtual and augmented reality experience may feel more natural and enhance the immersive experience rather than detract from it.

The virtual objects 112 may also be configured beyond object placement to personalize a configuration of a virtual reality environment as a whole. For example, a tourism virtual reality environment may be configured to enable a user to “walk” toward a landmark. While doing so, the experience personalization module 122 may place virtual objects as digital marketing content within the environment as well as personalize the environment as a whole. When walking through a city, for instance, users are primarily interested in the landmark (e.g., the Eifel Tower), and therefore changes may be made by selecting and configuring virtual objects 112 to surrounding buildings without detracting from the tourism experience. The virtual stores a user “walks” by may be personalized to sell things relevant to the experience and the user complete with window displays, mannequins and other virtual shoppers. In this way, a natural opportunity is supported to guide the user into the store (or other experience) where the user would have the opportunity to actually shop, thereby enhancing the immersive experience rather than detracting from it.

This technique may also be used to customizations other than marketing to personalize the experience for each individual. For example, different users may visit a cathedral for very different reasons. A virtual tourism application executed by a computing device 102, for example, through use of the techniques described herein may learn preferences of these users regarding “how” the different users choose the interact with the environment. One user, for instance, may “walk” in and enjoy the choir singing, while another may desire a completely empty cathedral to browse through with a virtual brochure “in their hand” at their own pace, while yet another may get a friendly guide that “walks” along beside them pointing out facts that are interesting to them. An additional user may be provided with the “stain glassed window” tour, while another would be provided with the “architecture tour” while another would be provided by the “history and famous people tour” through use of respective user profiles. Similarly, in a virtual hiking application, one user may experience lots of wildlife, while others get more wildflowers, while others view dramatic skies, and yet another would be provided with reptiles based on the user profile 120 even though typical users might be scared of reptiles.

Personalization of the virtual objects 112 may also be implemented to change an overall atmosphere of the environment. One example of this is the level of output as previously described, such as how much sound is exposed to a user overall as part of the environment. If virtually attending a sporting event, for instance, the volume of the stadium or the fans around the users significantly changes the way that in which users experience the game. In another example, the behavior of virtual human entities may also be changed, e.g., from rowdy screaming fans jumping up and down to a more subdued experience. When attending a virtual country concert, some users may prefer to hear themselves sing, other may prefer to include virtual human entities dancing in the isles, and so forth. Thus, in these examples different users may experience the digital experience content 110 (e.g., sporting event, concert) even without realizing that the experience was customized for them. Other examples include use of lighting, amount of virtual human entities, and so forth.

As put together in a single example, digital experience content 110 may be configured to create a virtual reality environment of a visit to Boston and a user profile 120 may indicate that a user likes sports, history, and food. Virtual objects 112 may be personalized to include a virtual guide and a small tour group based on the user profile 120 indicating a “how” of small grounds and spoken words. As the virtual tour proceeds from stop to stop, the virtual guide points out items of interest and explains the surrounding history. The user can also ask the virtual guide about important revolutionary figures and start mentioning historical figures at each stop automatically once the user profile is updated to learn this preference. Additionally, other virtual objects 112 configured as virtual human entities may also “go along” with the tour may ask questions about topics based on the user profile 120. If the guide starts talking about something that the user is not interested in (e.g., the user looks or walks away within the environment), the user profile 120 may also be updated by the experience personalization module 112. Not only would the tour group follow and change subjects to the new area of focus, but the experience personalization module 112 also learns and improves the future questions and answers. In each of these scenarios, a primary purpose of the digital experience content 110 does not change, but “how” interaction occurs within the experience does change in ways that might not be immediately noticeable to the users.

Digital Experience Content Recommendation

FIG. 7 depicts a system 700 in an example implementation showing generation of a user profile and use of the generated user profile to recommend digital experience content. FIG. 8 depicts a procedure 800 involving generation of a user profile that models user interaction with a plurality of items of digital experience content and use of the user profile to generate a digital experience content recommendation.

The following discussion describes techniques that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference is made interchangeably to FIGS. 7-8.

In the previous example, virtual objects are personalized based on a user profile that describes how a user interacts with virtual objects within the define augmented of virtual reality experience of the digital experience content 704. Similar techniques are employed in this example to generate recommendations regarding digital experience content based on past user interaction with other digital experience content.

As illustrated in FIG. 7, for instance, a user profile 120 is generated by a profile generation module 702 based on user interaction data 704, e.g., using a machine learning module 706. The user profile 120 models user interaction with a plurality of items of digital experience content 110 within a virtual or augmented reality environment (block 802). The user profile 120, for instance, may model interaction with particular items of digital experience content 110 as well as any actions, if any, that resulted from this interaction, e.g., conversion, amount of time the interaction lasted, and the “how” of the previous section.

A recommendation 708 is then generated that identifies a second item of digital experience content 710 based at least in part on the user profile 120 and data 712 describing a first item of digital experience content 714 (block 804). The experience recommendation module 124, for instance, may include an experience generation module 716. The experience generation module 710 is configured to recommend and then generate a second item of digital experience content 710 for output to the user to follow a first item of digital experience content 714, with which, the user is currently interacting.

As part of this, the experience generation module 710 includes an experience recommendation module 714 that is configured to generate the recommendation 708 based on the user profile 120 (i.e., the machine-learned model of user interaction) and data 712 describing the first item of digital experience content 714. The data 712, for instance, may be configured as metadata, may define the first item of digital experience content 714 itself, and so on. The data 712 along with the user profile 120 are used by the experience recommendation module 716 to select the second item of digital experience content 710 from storage 718 that is consistent with both the first item of digital experience content 714 and the modeled user interaction of the user profile 120. In this way, the user is provided with a second item of digital experience content 710 that may continue from a user's experience with the first item of digital experience content 714.

In the illustrated example, transition data 720 is generated by an experience transition module 722 that is usable to form a transition between the output of the first and second items of digital experience content 714, 710 (block 806). The transition data 720, for instance, may act as a visual and audio bridge between virtual reality environments of the first and second items of digital experience content 714, 710. Output is then controlled by the experience recommendation module 124 of the transition data 720 and the second item of digital experience content 710 (block 808), an example of which is described as follows.

A user 210 of the computing device 102, for instance, may output a virtual reality environment defined by the first item of digital experience content 714 of the Eiffel tower in a virtual tourism application. The user may then journey within this environment to a street intersection that is defined using transition data 720 to access other recommended digital experience content, e.g., different virtual tourism locations such as the pyramids at Giza, to the right the Grand Canyon, and to the left the great wall of China. As the user selects the path to take within the environment and between environments, the experience recommendation module 124 updates the user profile 120 so that recommendations 708 are generated with increased accuracy. If a user selects to go to a cathedral within a virtual tourism application, for instance, the next virtual recommendation may be other cathedrals or castles or buildings from a similar timeframe. Additionally, as the user walks around in the cathedral and studies the stained glass windows in detail, the experience recommendation module 124 learns what interests the user 210 naturally and the recommendations change to buildings with impressive stained glass. In this way, the experience recommendation module 124 may provide a seamless transition between environments and also learn from user selection of particular environments to update the user profile 120 without modal navigation through menus and lists.

In another example, the digital experience content supports stream of consciousness experiences through combination of the personalization and recommendation techniques described herein. For instance, a user may come to a wall with petroglyphs inscribed on it in a virtual reality environment defined by digital experience content. These drawings may have been automatically inserted as virtual object based on the user profile 120 which indicates that the user 210 has an affinity towards history. As the user 210 studies the petroglyphs, the user 210 may begin wondering about the people that left these drawings via a spoken utterance. In response, the experience recommendation module 120 can then guide the user subtly but intuitively into that other digital experience content such that as the user turns away from the wall, the user is surrounded by the civilization that left the markings and the mountainside as it may have looked back then through output of another item of digital experience content.

This may also support a digital marketing scenario by personalizing virtual objects as targeted advertisements. For instance, as a user “walks” down a city street in a virtual reality environment, the experience personalization module 122 may insert a virtual object as a target advertisement on the side of a bus sitting in traffic next to the user within the environment. If the advertisement catches the user's eye, the user may step on the bus to learn more, which may be monitored as equivalent to a user selection (e.g., “click”) in a web-based environment. Consequently, the user is then exposed to additional virtual objects having offers and product details while seeing the city move by in the background that relate to that advertisement. Once the user has finished, the user may step off the bus (e.g., generated via the transition data 720) at a next “location” defined by another recommended item of digital experience content. In this way, the user is provided with a natural experience through inclusion of personalized virtual objects and recommended digital experience content based on the user profile 120.

Example System and Device

FIG. 9 illustrates an example system generally at 900 that includes an example computing device 902 that is representative of one or more computing systems and/or devices that may implement the various techniques described herein. This is illustrated through inclusion of the experience interaction module 116 and the digital experience manager module 108. The computing device 902 may be, for example, a server of a service provider, a device associated with a client (e.g., a client device), an on-chip system, and/or any other suitable computing device or computing system.

The example computing device 902 as illustrated includes a processing system 904, one or more computer-readable media 906, and one or more I/O interface 908 that are communicatively coupled, one to another. Although not shown, the computing device 902 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 904 is representative of functionality to perform one or more operations using hardware. Accordingly, the processing system 904 is illustrated as including hardware element 910 that may be configured as processors, functional blocks, and so forth. This may include implementation in hardware as an application specific integrated circuit or other logic device formed using one or more semiconductors. The hardware elements 910 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 906 is illustrated as including memory/storage 912. The memory/storage 912 represents memory/storage capacity associated with one or more computer-readable media. The memory/storage component 912 may include volatile media (such as random access memory (RAM)) and/or nonvolatile media (such as read only memory (ROM), Flash memory, optical disks, magnetic disks, and so forth). The memory/storage component 912 may include fixed media (e.g., RAM, ROM, a fixed hard drive, and so on) as well as removable media (e.g., Flash memory, a removable hard drive, an optical disc, and so forth). The computer-readable media 906 may be configured in a variety of other ways as further described below.

Input/output interface(s) 908 are representative of functionality to allow a user to enter commands and information to computing device 902, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 902 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 902. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 902, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 910 and computer-readable media 906 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 910. The computing device 902 may be configured to implement particular instructions and/or functions corresponding to the software and/or hardware modules. Accordingly, implementation of a module that is executable by the computing device 902 as software may be achieved at least partially in hardware, e.g., through use of computer-readable storage media and/or hardware elements 910 of the processing system 904. The instructions and/or functions may be executable/operable by one or more articles of manufacture (for example, one or more computing devices 902 and/or processing systems 904) to implement techniques, modules, and examples described herein.

The techniques described herein may be supported by various configurations of the computing device 902 and are not limited to the specific examples of the techniques described herein. This functionality may also be implemented all or in part through use of a distributed system, such as over a “cloud” 914 via a platform 916 as described below.

The cloud 914 includes and/or is representative of a platform 916 for resources 918. The platform 916 abstracts underlying functionality of hardware (e.g., servers) and software resources of the cloud 914. The resources 918 may include applications and/or data that can be utilized while computer processing is executed on servers that are remote from the computing device 902. Resources 918 can also include services provided over the Internet and/or through a subscriber network, such as a cellular or Wi-Fi network.

The platform 916 may abstract resources and functions to connect the computing device 902 with other computing devices. The platform 916 may also serve to abstract scaling of resources to provide a corresponding level of scale to encountered demand for the resources 918 that are implemented via the platform 916. Accordingly, in an interconnected device embodiment, implementation of functionality described herein may be distributed throughout the system 900. For example, the functionality may be implemented in part on the computing device 902 as well as via the platform 916 that abstracts the functionality of the cloud 914.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. In a digital medium environment to personalize user interaction with digital experience content as part of a virtual or augmented reality environment, a method implemented by at least one computing device, the method comprising:
receiving, by the at least one computing device, a user profile that models how user interaction occurs with respect to virtual objects within a virtual or augmented reality environment;
obtaining, by the at least one computing device, digital experience content defining a virtual or augmented reality environment;
selecting, by the at least one computing device, a virtual object for inclusion as part of the digital experience content based at least in part on the user profile;
generating, by the at least one computing device, the digital experience content to support user interaction with the selected virtual object as part of the virtual or augmented reality environment; and
outputting, by the at least one computing device, the generated digital experience content as including the selected virtual object.

2. The method as described in claim 1, wherein the user profile models how the user interaction occurs with respect to different types of user interaction supported by the virtual objects within the virtual or augmented reality environment and the selecting of the virtual object is based at least in part on the modeled types.

3. The method as described in claim 1, wherein the user profile models how the user interaction occurs with respect to different amounts of user interaction supported by the virtual objects within the virtual or augmented reality environment and the selecting of the virtual object is based at least in part on the modeled amounts.

4. The method as described in claim 1, wherein the user profile models how the user interaction occurs with respect to different levels of output supported by the virtual objects within the virtual or augmented reality environment and the selecting of the virtual object is based at least in part on the modeled levels.

5. The method as described in claim 4, wherein the different levels of output include a display area, audio volume level, or number of included words.

6. The method as described in claim 1, wherein the user profile models how the user interaction occurs with respect to different types of of output supported by the virtual objects within the virtual or augmented reality environment and the selecting of the virtual object is based at least in part on the modeled output types.

7. The method as described in claim 1, wherein the user profile further models the user interaction as relating to achieving an action within the virtual or augmented reality environment.

8. The method as described in claim 7, wherein the action includes conversion of a good or service and the selected virtual object includes digital marketing content.

9. The method as described in claim 1, wherein the generating is based at least in part on the user profile.

10. The method as described in claim 1, wherein the user profile models an individual user or a segment of a user population.

11. In a digital medium environment, a system comprising:
a profile generation module implemented at least partially in hardware of at least one computing device to generate a user profile based on user interaction data that models how user interaction occurs with respect to virtual objects within a virtual or augmented reality environment; and
an experience generation module implemented at least partially in hardware of the at least one computing device to:
select a virtual object based on the user profile; and
generate digital experience content as including the selected virtual object to support how the user interaction is to occur with the virtual object within a virtual or augmented reality environment.

12. The system as described in claim 11, wherein the user profile models how the user interaction occurs with respect to different types of user interaction supported by the virtual objects within the virtual or augmented reality environment and the experience generation module is configured to select the virtual object based at least in part on the modeled types.

13. The system as described in claim 11, wherein the user profile models how the user interaction occurs with respect to different amounts of user interaction supported by the virtual objects within the virtual or augmented reality environment and the experience generation module is configured to select the virtual object based at least in part on the modeled amounts.

14. The system as described in claim 11, wherein the user profile models how the user interaction occurs with respect to different levels of output supported by the virtual objects within the virtual or augmented reality environment and the experience generation module is configured to select the virtual object based at least in part on the modeled levels.

15. The system as described in claim 11, wherein the user profile models how the user interaction occurs with respect to different types of output supported by the virtual objects within the virtual or augmented reality environment and the experience generation module is configured to select the virtual object based at least in part on the modeled output types.

16. In a digital medium environment, a system comprising:
means for generating a user profile, based on user interaction data, to model user interaction with a plurality of items of digital experience content within a virtual or augmented reality environment; and
means for generating a recommendation that identifies a second item of digital experience content based at least in part on the user profile and data describing a first item of digital experience content.

17. The system as described in claim 16, wherein the generating means processes the data describing the first item of digital experience content and the model of interaction of the user profile using machine to generate the recommendation.

18. The system as described in claim 16, further comprising means for generating transition data usable to form a transition between the output of the first and second items of digital experience content.

19. The system as described in claim 16, wherein the user profile further models how the user interaction occurs with respect to virtual objects within the virtual or augmented reality environment of the plurality of items of digital experience content.

20. The system as described in claim 19, wherein the user profile models how the user interaction occurs with respect to different amounts of user interaction supported by the virtual objects within the virtual or augmented reality environment, different levels of output supported by the virtual objects within the virtual or augmented reality environment, or different types of output supported by the virtual objects within the virtual or augmented reality environment.
